(19) United States
(12) Patent Application Publication
(10) Pub. No.: US 2021/0331728 A1
(43) Pub. Date: Oct. 28, 2021

(54) UNMANNED MOVABLE PLATFORMS

(71) Applicant: LINGDONG TECHNOLOGY (BEIJING) CO. LTD, Beijing (CN)

(72) Inventors: Ou Qi, Beijing (CN); Jie Tang, Beijing (CN)

(73) Assignee: LINGDONG TECHNOLOGY (BEIJING) CO. LTD, Beijing (CN)

(21) Appl. No.: 16/334,018

(22) PCT Filed: Jan. 16, 2019
(86) PCT No.: PCT/CN2019/072044

§ 371 Date: Mar. 17, 2019

(51) Int. Cl. B62B 5/00; G05D 1/02; B65G 1/04

(52) U.S. Cl. CPC B62B 5/0069; B62B 5/004; G05D 1/0231; B62B 2202/24; B65G 1/04; G05D 2201/0216; G05D 1/0242

(57) ABSTRACT

The present disclosure discloses an unmanned movable platform that includes one or more unmanned moveable vehicles that are capable of operating different modes. Under the following mode, the unmanned movable vehicles use their vision sensors to follow the operator while using other sensors to collect environmental information to smartly avoid obstacles. Under the autonomous navigation mode, the unmanned movable vehicles may autonomously navigate along a pre-stored route to complete a predefined task, such as loading or discharging an inventory.

### TECHNICAL FIELD

The present disclosure generally relates to unmanned movable platforms. Specifically, the present disclosure relates to shopping carts or warehouse fulfillment carts with autonomous capability.

### BACKGROUND

In post-Internet era, both offline and online shopping have been widely adapted by people as an important means of purchasing commodities. Although people still go to local stores, such as Ikea™ and Home Depot™, to purchase things they need immediately, and go to online retailer, such as Amazon™, JD™ and Taobao™, for goods that they can wait to have. Most of the shopping carts in local stores, however, are not automatic and people have to push the shopping carts around when shopping. Further, as shown in FIG. 1A, the handle of the shopping cart extends across one side of the shopping cart, people have difficulty to load/discharge goods they purchase to the shopping cart from the handle side. Online shopping has the same problem. Warehouse employees uses warehouse fulfillment carts to load/discharge inventories. But the warehouse fulfillment cart is not self-driving and, as shown in FIG. 1B, the big handle obstructs a warehouse employee from loading/discharging inventories from that side.

Therefore, there is a need to provide a smart cart that either automatically follows its operator or autonomously navigates along aisles of warehouse racks, allowing inventories to be loaded/discharges from all sides thereof.

### SUMMARY

The present disclosure discloses an unmanned movable platform that includes one or more unmanned moveable vehicles that are capable of operating different modes. Under the following mode, the unmanned movable vehicles use their vision sensors to follow the operator while using other sensors to collect environmental information to smartly avoid obstacles. Under the autonomous navigation mode, the unmanned movable vehicles may autonomously navigate along a pre-stored route to complete a predefined task, such as loading or discharging an inventory.

To this end, an aspect of the present disclosure is related to an unmanned movable platform (UMP). The UMP includes autonomous driving units. Each driving unit of the one or more autonomous driving units includes: a base including at least one loading side and a loading surface to take load from a loading path through loading side of the base; one or more arms connected to the base near the loading side and protruded up from the base at a predetermined angle without obstructing a process of placing load on the base from the loading side through the loading path (e.g., free from obstructing the process). Each of the one or more autonomous driving units further includes one or more motorized casters connected to the base, each of the one or more motorized casters including: a first axle connected to the base at a predetermined angle or at substantially the predetermined angle; a motorized wheel passively rotatable along the first axle and actively rotatable along a second axle passing through a rotation center of the at least one wheel under a control of the one or more control module; and a connection mechanism connecting the first axle and the second axle.

The UMP further includes one or more vision modules including one or more steerable sensors to obtain environmental information of the autonomous driving unit. The one or more steerable sensors are mounted on an upper portion of the one or more arms.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1A is a schematic illustration of a conventional shopping cart that people use in grocery stores;

FIG. 1B is a schematic illustration of a warehouse fulfillment cart that warehouse employees use in warehouses;

FIG. 2 illustrates a control system of an unmanned movable platform according to exemplary embodiments of the present disclosure;

FIG. 3 is a schematic illustration of an unmanned movable vehicle according to exemplary embodiments of the present disclosure;

FIG. 4 is a schematic illustration of the unmanned movable vehicle operating under a following mode according to exemplary embodiment of the present disclosure; and

FIG. 5 is a schematic illustration of the unmanned movable vehicle operating under an autonomous navigation mode according to exemplary embodiments of the present disclosure.

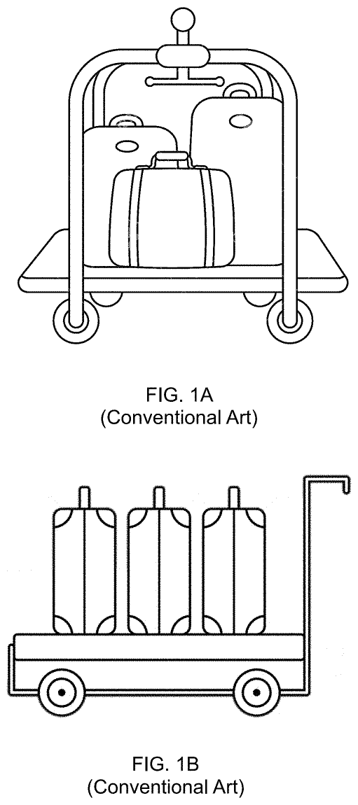

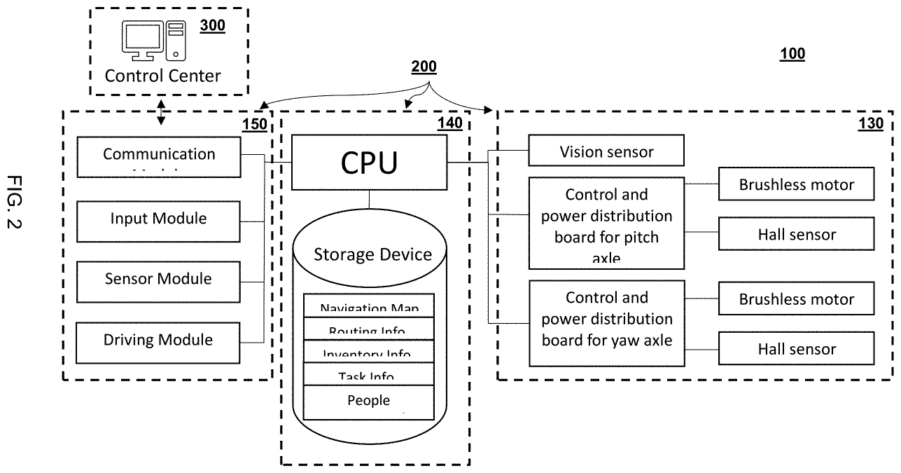

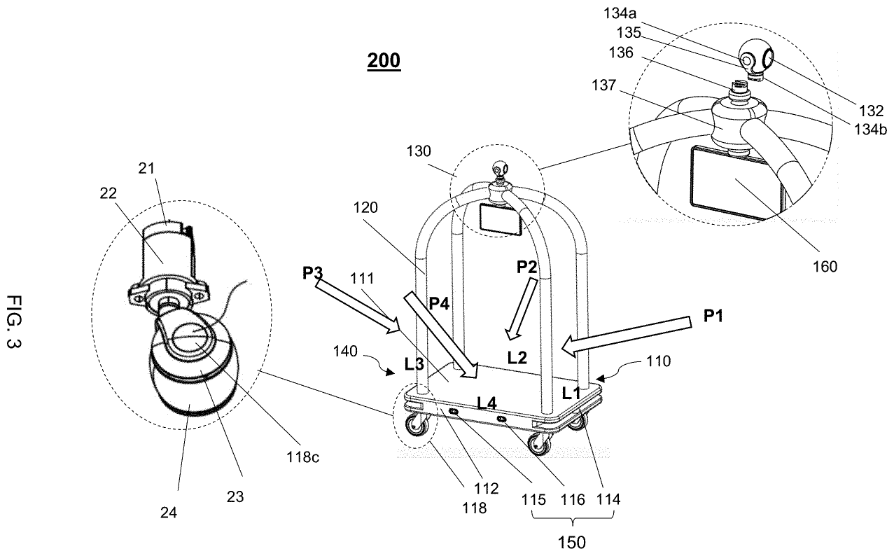

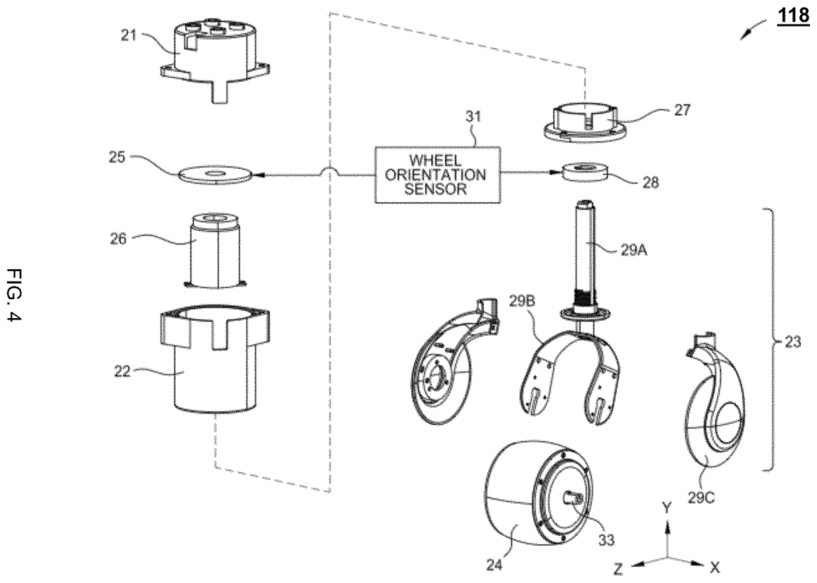

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may or may not be implemented in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to unmanned moving platforms, it should also be understood that this is only one exemplary embodiment. The system or method of the present disclosure may be applied to any other kind of moving platforms, such as unmanned aircraft platform.

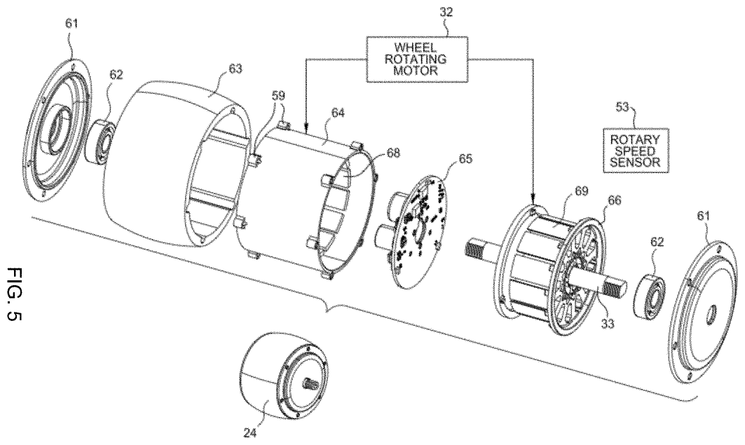

FIG. 2 illustrates a control system of an unmanned movable platform (UMP) 100 according to exemplary embodiments of the present disclosure. The UMP 100 may include an unmanned movable vehicle (UMV) 200 communicating with a control center 300. The control system of the UMV 200 may include a control module 140 wired or wirelessly connected to a vision module 130 and an auxiliary module 150.

The control center 300 may be a server. For example, the control center 300 may be one or more managing system of a warehouse, hotel, or grocery store. The control center 300 may be local to the UMV 200, i.e., the control center 300 may be mounted on the UMV 200. Additionally or alternatively, the control center 300 may be remote to the UMV 200. In the later scenario, the UMV 200 may communicate with the control center 300 via wireless communication.

The vision module 130 may include one or more vision sensors (e.g., imaging devices capable of detecting visible, infrared, or ultraviolet light, such as cameras), proximity or range sensors (e.g., ultrasonic sensors, LIDAR (Light Detection and Ranging), infrared imaging devices, or ultraviolet imaging devices, or any combination thereof. The sensor may provide static sensing data (e.g., a photograph) or dynamic sensing data (e.g., a video).

The vision module 130 may also include circuits and mechanisms to motorize the vision sensor. For example, the vision module 130 may include a first control and power distribution board to electronically connected to a brushless motor to steer the vison sensor around a pitch axle. The pitch angle may be measured by a first hall sensor. A hall sensor may be configured to indicate the relative positions of stator and rotor of the brushless motor. The first control and power distribution boards may receive measured signals from the first hall sensor and controlled the rotation of the first brushless motor accordingly. The vision module 130 may also include a second control and power distribution board to electronically connected to a brushless motor to steer the vison sensor around a yaw axle. The yaw angle may be measured by a second hall sensor. The second control and power distribution boards may receive measured signals from the second hall sensor and controlled the rotation of the second brushless motor accordingly. The first and second control and power distribution board may be integrated into a single board.

The auxiliary modules 150 may include a communication module, an input module, a sensor module, and a driving module.

The communication module may include one or more antennas and transceivers, configured to communicate with a module remote from the UMV or with the control center 300.

The input module may be an input device under communication with the control module 140, configured to input operation direction and/or command to the control module 140. For example, the input module may be a keyboard device or a touch screen device communicated with the control module 140 via wired or wireless communicate.

The driving module may be configured to provide power and control for navigation of the UMV. For example, the UMV 200 may include one or more casters, each caster is powered by a brushless DC motor. Accordingly, the driving module may include one or more control and power distribution boards to electronically connected to each of the brushless DC motor to provide power thereto. The rotation of each brushless DC motor may be measured by a hall sensor. The one or more control and power distribution boards may receive measured signals from each of the hall sensor and controlled the rotation of each brushless DC motor accordingly.

The sensor module may include one or more sensors for surveying one or more targets. Any suitable sensor may be incorporated into the sensor module, such as a speedometer, an audio capture device (e.g., a parabolic microphone), or any combination thereof. In some embodiments, the sensor may provide sensing data for a target. Alternatively or in combination, the sensor module may include one or more emitters for providing signals to one or more targets. Any suitable emitter may be used, such as an illumination source or a sound source.

The sensor module may also include one or more sensors configured to collect relevant data, such as information relating to the UAV state, the surrounding environment, or the objects within the environment. Exemplary sensors suitable for use with the embodiments disclosed herein include location sensors (e.g., global positioning system (GPS) sensors, mobile device transmitters enabling location triangulation), compasses, gyroscopes, inertial sensors (e.g., accelerometers, gyroscopes, inertial measurement units (IMUs)), altitude sensors, attitude sensors (e.g., compasses, IMUs) pressure sensors (e.g., barometers), audio sensors (e.g., microphones) or field sensors (e.g., magnetometers, electromagnetic sensors). Any suitable number and combination of sensors may be used, such as one, two, three, four, five, or more sensors. The data may be received from sensors of different types (e.g., two, three, four, five, or more types). Sensors of different types may measure different types of signals or information (e.g., position, orientation, velocity, acceleration, proximity, pressure, etc.) and/or utilize different types of measurement techniques to obtain data. For example, the sensors may include any suitable combination of active sensors (e.g., sensors that generate and measure energy from their own energy source) and passive sensors (e.g., sensors that detect available energy). As another example, some sensors may generate absolute measurement data that is provided in terms of a global coordinate system (e.g., position data provided by a GPS sensor, orientation data provided by a compass), while other sensors may generate relative measurement data that is provided in terms of a local coordinate system (e.g., relative angular velocity provided by a gyroscope; relative translational acceleration provided by an accelerometer; relative distance information provided by an ultrasonic sensor, and/or LIDAR). In some instances, the local coordinate system may be a body coordinate system that is defined relative to the unmanned vehicle.

The sensors may be configured to collect various types of data, such as data relating to the UMV 200, the surrounding environment, or objects within the environment. For example, at least some of the sensors may be configured to provide data regarding a state of the UMV 200. The state information provided by a sensor may include information regarding a spatial disposition of the UMV 200 (e.g., location or position information; orientation information such as yaw). The state information may also include information regarding motion of the UMV 200 (e.g., translational velocity, translation acceleration, angular velocity, angular acceleration, etc.). A sensor may be configured, for example, to determine a spatial disposition and/or motion of the UMV 200 with respect to up to 3 degrees of freedom (e.g., 2 degrees of freedom in position and/or translation, 1 degrees of freedom in orientation and/or rotation). The state information may be provided relative to a global coordinate system or relative to a local coordinate system (e.g., relative to the unmanned vehicle or another entity). For example, a sensor may be configured to determine the distance between the UMV 200 and the user controlling the UMV, or the distance between the UMVs when a group of UMVs navigate together.

The data obtained by the sensors may provide various types of environmental information. For example, the sensor data may be indicative of an environment type, such as an indoor environment and outdoor environment. The sensor data may also provide information regarding current environmental conditions, including weather (e.g., clear, rainy, snowing), visibility conditions, wind speed, time of day, and so on. Furthermore, the environmental information collected by the sensors may include information regarding the objects in the environment, such as the obstacles described herein. Obstacle information may include information regarding the number, density, geometry, and/or spatial disposition of obstacles in the environment.

In some embodiments, sensing results are generated by combining sensor data obtained by multiple sensors, also known as “sensor fusion.” For example, sensor fusion may be used to combine sensing data obtained by different sensor types, including as GPS sensors, inertial sensors, vision sensors, LIDAR, ultrasonic sensors, and so on. As another example, sensor fusion may be used to combine different types of sensing data, such as absolute measurement data (e.g., data provided relative to a global coordinate system such as GPS data) and relative measurement data (e.g., data provided relative to a local coordinate system such as vision sensing data, LIDAR data, or ultrasonic sensing data). Sensor fusion may be used to compensate for limitations or inaccuracies associated with individual sensor types, thereby improving the accuracy and reliability of the final sensing result.

The control module 140 may include at least one processor (CPU) and at least one storage device. The processor may connect to modules in the auxiliary modules 150 and the vision module 130. The processor may also communicate with the control center 300 via the communication module of the auxiliary modules 150.

The storage device may be one or more transitory processor-readable storage media or non-transitory processor-readable storage media, such as flash memory, solid disk, ROM, and RAM, or the like. The storage device may include sets of instructions for operating the UMV 200. For example, the storage device may include a set of instructions for object recognition (such as people recognition information, obstacle recognition information, etc.) based on signals received from the vision module 130 and environment recognition based on signals received from the sensor module. The storage device may also include information about a navigation map, routing information, inventory information, and task information. Accordingly, when the processor receives a task from the input module and/or from the control center, the processor may automatically execute the task without human interfere. During operation, the control module 140 may execute the set of instructions to receive environmental information associated with the UMV 200 from the auxiliary modules 150 (e.g., the sensor module), and based on the signals, direct an autonomous driving unit of the UMV 200 to navigate under a predetermined navigation mode. Details of the autonomous driving unit is introduced in elsewhere of the present disclosure.

For example, an operator may input a command from the input device (i.e., the input module, such as a keyboard and/or a touch screen), directing the control module 140 to operate under a “following mode.” The command may include information of the operator (operator's ID or contour), or an instruction of recognizing the operator. After receiving the command, the processor may first recognize the operator. When the command includes the information of the operator, the processor may read the operator's information; when the command includes the instruction of recognizing the operator, the processor may turn on the vision sensor to recognize the operator's face and contour. The processor may then try to match the face and contour with the people recognize information stored in the storage device. When the face and contour does not match any record, the processor may store the face and contour as new people recognize information. After the above operation, the processor may execute the people recognize information and the set of instructions from the storage device to follow the operator. To this end, the processor may keep tracking the operator's position and drive the UMV 200 to keep a predetermined range of distance from the operator while autonomously avoiding any obstacle happen to interfere the UMV to follow the operator. For example, the processor may distinguish the operator from one or more interference persons detected by the one or more sensors in the sensor module of the auxiliary modules 150. The operator may guide the UMV 200 to navigate along a route. For example, the operator may be a hotel guest walking from a hotel entrance to his/her room, or a warehouse employee walking to pick up an inventory, or a local grocery store customer walking along aisles to pick up food. In operator may walk in front of the UMV 200. The processor may direct the driving module to provide power and control to the UMV 200 to follow the operator. The processor may also save the route (through SLAM or other algorithms) the operator walks through to the storage device for use next time. For example, the processor may record all data it got from every sensor (including camera and speedometer, and proximity sensors like LIDAR or ultra-sonic sensor) throughout the way and recognize the environment. Then the UMV will be able to go by itself next time.

In another example, the control center (e.g., the managing system of a warehouse, hotel, or grocery store) may send a command to direct the control module 140 to operate under an “autonomous navigation mode.” The command may include information of a route stored in the storage device. For example, the control center may be a hotel management system, the command may be to direct the UMV 200 to send food ordered by a guest to a particular room in the hotel; or the control center may be a warehouse management system and the command may be to direct the UMV 200 to move to a particular aisle to load an inventory. After receiving the command, the processor may turn on the vision sensor in the auxiliary modules and/or other sensors in the sensor module to recognize the environment around the UMV (e.g., to avoid obstacles appear on the route). After the above operation, the processor may read the routing information and the set of instructions from the storage device to navigate autonomously, using the routing information as a reference to guide the navigation. To this end, the processor may keep tracking the environment information collected by the vision sensor and the sensor module, compare the environment information with the routing information, and drive the UMV 200 to avoid any obstacles (e.g., persons walking across the route in the command or things appear in the route) happens to appear in the route.

The UMV 200 described herein may be operated completely autonomously (e.g., by a suitable computing system such as an onboard controller), semi-autonomously (e.g., under human intervention), or manually (e.g., by a human user). The UMV 200 may receive commands from a suitable entity (e.g., human user or a control center) and respond to such commands by performing one or more actions. For example, as described above, the UMV 200 may be controlled to follow an operator, or the UMV 200 may be controlled to depart from a starting location, move along a predetermined path to take loads, and then discharge the load at the end of the predetermined path, and so on. As another example, the UMV 200 may be controlled to move at a specified velocity and/or acceleration (e.g., with up to two degrees of freedom in translation and up to one degrees of freedom in rotation) or along a specified movement path. Furthermore, the commands may be used to control one or more UMV 200 components, such as the components described herein (e.g., sensors, actuators, propulsion units, payload, etc.). For example, some commands may be used to control the position, orientation, and/or operation of a UMV 200 payload such as a camera.

The UMV 200 may be configured to operate in accordance with one or more predetermined operating rules. The operating rules may be used to control any suitable aspect of the UMV 200, such as the position, orientation (e.g., yaw), velocity (e.g., translational and/or angular), and/or acceleration (e.g., translational and/or angular) of the UMV 200. In some embodiments, the operating rules may be adapted to provide automated mechanisms for improving UMV 200 safety and preventing safety incidents. For example, the operating rules may be designed such that the UMV 200 is not permitted to navigate beyond a threshold speed for safety concerns, e.g., the UMV 200 may be configured to move no more than 20 miles per hour.

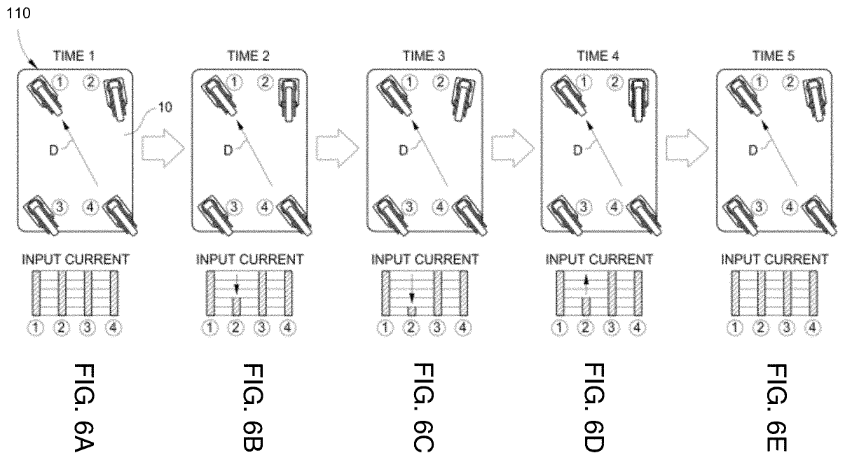

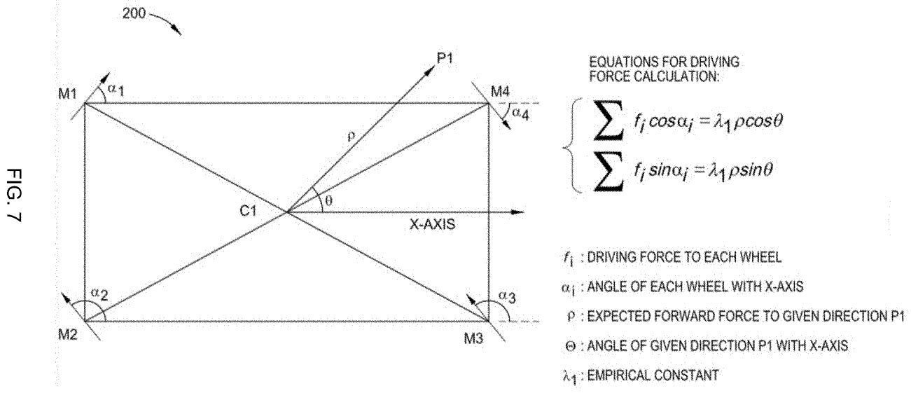

FIG. 3 illustrates the unmanned movable vehicle (UMV) 200 in accordance with embodiments of the present disclosure. Purely for illustration purpose, the present disclosure uses a warehouse fulfillment cart and a hotel luggage cart as examples to demonstrate the systems for the unmanned movable platform. The embodiments provided herein may be applied to various types of unmanned vehicles. For example, the unmanned vehicle may also be applied to a grocery shopping cart.

The UMV 200 may include at least one autonomously driving unit (ADU) 110, at least one arm 120, at least one vision module 130, at least one control module 140, and the auxiliary modules 150.

The ADU 110 may include one or more bases 112, one or more control module 140, one or more casters 118, and one or more sensors 114, 115, 116.

The one or more casters 118 may connect to a lower surface of the base 112. For example, the ADU 110 may include four (4) casters 118 connected to the lower surface of the base 112. The casters 118 may include at least one motorized caster. Each motorized caster may include a motorized wheel 24 and an upper slip ring housing 21 coupled to a lower slip ring housing 22. The motorized wheel 24 may be coupled to the lower slip ring housing 22 by a wheel mount 23. The motorized wheel 24 is configured to both roll to move the base 112 and rotate (e.g. pivot or swivel) to change the direction of movement of the base 112.

The casters 118 may all be motorized casters or a mixture of motorized and normal (non-motorized) casters. In one embodiment, two rear motorized casters may be motorized while the two front motorized casters may be normal casters, e.g. non-motorized. In one embodiment, the two front motorized casters may be motorized while the two rear motorized casters may be normal casters, e.g. non-motorized. In one embodiment, any one, two, or three of the casters 118 may be motorized while the other casters 118 are normal wheel assemblies, e.g. non-motorized.

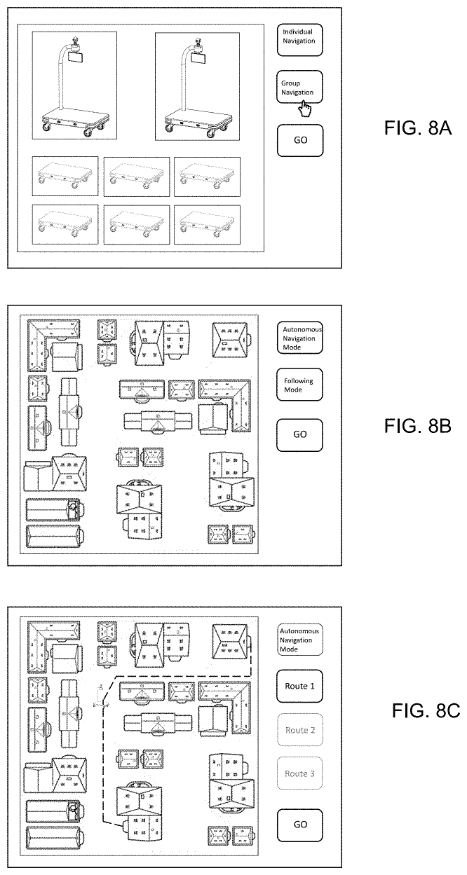

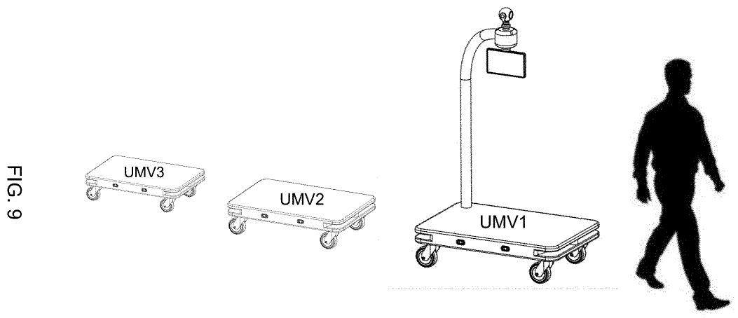

FIG. 4 is an exploded view of one of the motorized casters 118 of the smart luggage system 100 according to one embodiment. The motorized caster 118 may include a slip ring 26 disposed within the upper slip ring housing 21 and the lower slip ring housing 22. The slip ring 26 may be configured to transmit electrical signals between components within the ADU 110 that are stationary and components within the motorized caster 118 that are rolling and/or rotating.

The motorized caster 118 may further include a magnetic rotary encoder 25, a bearing assembly 27, and a magnet 28 all coupled to the upper slip ring housing 21 and the lower slip ring housing 22. The combination of the magnetic rotary encoder 25 and the magnet 28 may function as a wheel orientation sensor 31 configured to measure and transmit a signal corresponding to the orientation of the motorized wheel 24. Information regarding the orientation of the motorized wheel 24, such as relative to the luggage 10, may be used to help direct the luggage 10 in a given direction.

The motorized wheel 24 may be coupled to the upper slip ring housing 21 and the lower slip ring housing 22 by the wheel mount 23. The wheel mount 23 may include a shaft 29A, a yoke 29B, and an outer housing 29C. The motorized wheel 24 has an axle 32 that is secured within the yoke 29B. The motorized wheel 24 is configured to roll along the ground relative to the wheel mount 23 about the X-axis, which is parallel to the longitudinal axis of the axle 33 as shown (e.g. the centerline of the motorized wheel 24). The motorized wheel 24 and the wheel mount 23 may be rotatable (e.g. can pivot or swivel) together relative to the longitudinal axis of the upper slip ring housing 21 and the lower slip ring housing 22 about the Y-axis, which is parallel to the longitudinal axis of the shaft 29A as shown. Alternatively, the motorized wheel 24 and the wheel mount 23 may be rotatable together around the longitudinal axis of the shaft 29A, which has a predetermined angle with respect to the Y-axis. The motorized wheel 24 may be configured to roll and rotate about two different axes. In one embodiment, the axis about which the motorized wheel 24 rolls (e.g. X-axis) may be offset from the axis about which the motorized wheel 24 rotates (e.g. Y-axis and/or axis of 29A). In other words, the Y-axis and/or axis of 29A about which the motorized wheel 24 rotates is offset from the X-axis, which is the centerline about which the motorized wheel 24 rolls. In one embodiment, the axis about which the motorized wheel 24 rolls (e.g. X-axis) may be in the same plane as the axis about which the motorized wheel 24 rotates (e.g. Y-axis and/or axis of 29A). In other words, the Y-axis and/or axis of 29A about which the motorized wheel 24 rotates is mutually orthogonal and coincides with the X-axis, which is the centerline about which the motorized wheel 24 rolls.

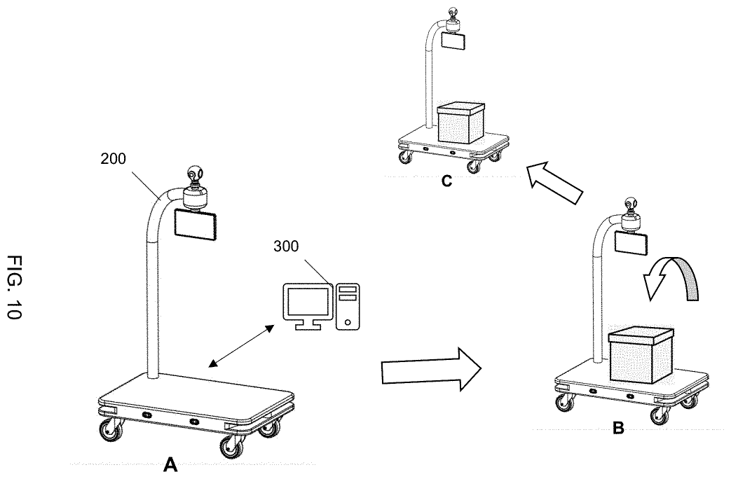

FIG. 5 is an exploded view of one motorized wheel 24 according to one embodiment. The motorized wheel 24 may include outer covers 61, and a motor. The motor may be a brushless DC motor. The motor may further include bearings 62, a housing 63, a rotor 64, a wheel motor controller 65, a stator 66, and a rotary speed sensor 53. The bearings 62, the rotor 64, the wheel motor controller 65, the stator 66, and the rotary speed sensor 53 may be disposed within the housing 63. The outer covers 61 may be coupled to the opposite sides of the housing 63 to enclose the components within. In one embodiment, the rotary speed sensor 53 may be positioned outside of the housing 63.

The housing 63 and the rotor 64 may be rotationally coupled together through a pin and groove engagement 59. The rotor 64 may include a plurality of magnets 68 that interacts with a plurality of windings 69 of the stator 66 to form a wheel rotating motor 32 configured to rotate the motorized wheel 24 when powered. The wheel rotating motor 32 may be any type of electric motor. The axle 33 may extend through the housing 63 and the outer covers 61 to connect the motorized wheel 24 to the yoke 29B of the wheel mount 23.

The wheel motor controller 65 may be configured to control the rotary speed of the motorized wheel 24 about the axle 32. The wheel motor controller 65 may be configured to control the amount of power, e.g. current, supplied to the stator 66 of the wheel rotating motor 32, which controls the speed of rotation of the rotor 64 and housing 63 about the axle 67. The rotary speed sensor 53 may be configured to measure the rotary speed of the motorized wheel 24. The rotary speed sensor 53 may be configured to transmit a signal to the wheel motor controller 65 corresponding to the measured rotary speed.

In one embodiment, the wheel motor controller 65 may be located within the housing 63 of the motorized wheel 24. In one embodiment, the wheel motor controller 65 may be separate from the motorized wheel 24. For example, the wheel motor controller 65 may be located inside the ADU 110 as part of the control module 140. In one embodiment, at least one wheel motor controller 65 may be located within the housing 63 of one motorized wheel 24, and at least one other wheel motor controller 65 may be located inside the ADU 110 separate from one motorized wheel 24.

In summary, the motor of the motorized caster may be a brushless DC motor including a stator 66 and a rotor 64. The rotor 64 may fixedly be attached to the wheel 24, and the stator 66 may be fixedly connected to the horizontal axle 33. When the brushless DC motor operates, the rotor 66 may rotate around a center line of the stator 66 or the horizontal axle 33. Accordingly, the motorized wheel 24 may actively rotate around the horizontal axle 33, which passes through the center line of the stator 66 and/or the wheel 24. As introduced above, the rotation of the brushless DC motor may be controlled by the wheel motor controller 65 and/or the at least one control module 140. For example, each of the brushless DC motors for the caster 118 is controlled by a control and power distribution board through a hall sensor, which measures the relative positions of stator and rotor of motor.

The upper slip ring housing 21 may be connected to the lower surface of the base 112 at a predetermined angle. For example, the supporting axle 118d may be perpendicularly or substantially perpendicularly connected to the lower surface of the base 112, or may be connected to the lower surface at an angle other than 90°, such as 85°, 80° or any other suitable angle. Collectively, the upper slip ring housing 21 and the lower slip ring housing 22 may form an axle to fixedly connect the wheel 24 to the base 112.

The combination of slip ring 26 and the wheel assembly 20 may form a connection mechanism, connecting the horizontal axle 33 to the base 140 via slip ring housing 21, 22. The slip ring 26 is powerless. Accordingly, the motorized wheel 24 may passively rotate around the center line of axle 29 and/or Y-axis (supporting axle).

Although the caster 118 passively rotate around the supporting axle, the ADU 110 may conduct planed navigation through proper control strategy.

FIGS. 6A-6E illustrate a sequence of operation of the ADU 110 according to some embodiments.

FIG. 6A illustrates the ADU 110 moving in a given direction “D” with each wheel 1, 2, 3, 4 (e.g. the casters 118) oriented in the given direction “D”. The orientation of the wheels 1, 2, 3, 4 is measured by the wheel orientation sensor 31 and communicated to the CPU in the control module 140. Based on the wheel orientation, the CPU directs the wheel motor controller 65 to provide the same amount of input current to each motorized wheel among wheels 1, 2, 3, 4 to move the luggage 10 in the given direction “D”.

FIG. 6B illustrates the ADU 110 moving in a given direction “D” but with the wheel 2 oriented in a direction that is different than the given direction “D”. As the ADU 110 moves along the ground, the wheel 2 can be forced into a direction different by surrounding environmental influences, such as the roughness or unevenness of the ground. Once the unintended turning of the wheel 2 is detected by the wheel orientation sensor 31, the CPU in the control module 140 is configured to direct the wheel motor controller 65 to reduce or stop the input current to the wheel 2 if there is a force being applied by the wheel 2 that is forcing the ADU 110 in a direction that is different than the given direction “D”.

FIG. 6C illustrates the ADU 110 moving in a given direction “D” but with the wheel 2 further turned in a direction different from the given direction “D”. The CPU 72 is configured to direct the wheel motor controller 65 to further reduce or stop the input current to the wheel 2 to prevent the wheel 2 from influencing the luggage 10 to move in a direction different from the given direction “D”. The wheel 2 may be allowed to move freely while the luggage 10 is driven by the remaining wheels 1, 3, 4 if all of the input current to the wheel 2 is stopped.

FIG. 6D illustrates the ADU 110 moving in a given direction “D” but with the wheel 2 oriented back into a direction that is similar to the given direction “D”. The wheel 2 can be turned by contact with the roughness or unevenness of the ground and/or by the drive force applied to the ADU 110 by the remaining wheels 1, 3, 4. Once the wheel orientation sensor 31 detects that the wheel 2 is oriented into a direction that is similar to the given direction “D”, the CPU of the control module 140 is configured to direct the wheel motor controller 65 to increase the input current to the wheel 2 to help force the orientation of the wheel 2 in the same direction as the given direction “D”.

FIG. 6E illustrates the ADU 110 moving in a given direction “D” with all of the wheels 1, 2, 3, 4 oriented in the given direction “D”. Based on the wheel orientation, the CPU of the control module 140 directs the wheel motor controller 65 to provide the same amount of input current to each wheel 1, 2, 3, 4 to continue to move the ADU 110 in the given direction “D”.

FIGS. 6A-6E illustrate only one sequence of operation. The ADU 110 is capable of operating across any number of sequences as the wheels 1, 2, 3, 4 are continuously moving over different ground surfaces. The CPU of the control module 140 continuously monitors the orientation and speed of each wheel 1, 2, 3, 4, as well as the other information provided by the other components of the ADU 110. The CPU is configured to continuously instruct the wheel motor controller 65 to increase, decrease, or stop current input to any or all of the wheels 1, 2, 3, 4, respectively, as needed to maintain the movement of the ADU 110 in the given direction “D”. The orientation, rotary speed, and/or input current supplied to each wheel 1, 2, 3, 4 may be different or the same as any other wheel 1, 2, 3, 4 at any point in time.

FIG. 7 illustrates a driving force calculation programmed into the CPU of the ADU 110 (labeled as C1) according to one embodiment. Once there is an unintended turning of any wheel (labeled as M1, M2, M3, M4) that is detected by the wheel orientation sensor 31, then the CPU will instruct the wheel motor controller 65 to reduce or stop the input current to the respective wheel rotating motor 32 if there is a driving force being applied by any of the wheels in a direction different than the expected forward force to the given direction P1. As shown in FIG. 7, the angle of each wheel and the angle of the given direction P1 are measured relative to the X-axis.

Referring back to FIG. 3, the base 112 may be of any shape. For example, the base 112 may be, or substantially be, circular shape, triangular shape, quadrangular shape (e.g., rectangular shape or diamond shape), hexangular shape, etc. Merely for illustration purpose, FIG. 3 shows an autonomous driving unit base with a rectangular shape or a substantially rectangular shape (e.g., a rectangular or substantially rectangular shape with rounded corners, or a rounded rectangular shape). The driving unit base includes four (4) loading sides L1, L2, L3, and L4. Each loading sides correspond to a side of the rectangular or substantially rectangular shape.

The base 112 may include a loading surface 111 to take loads from the loading sides of the base. The load may be of any thing that the ADU 110 carries. The load may be placed on the loading surface 111 through loading paths from any direction over the corresponding loading side. For example, in the rectangular base 110 shown in FIG. 3, loading path P1 may pass through the loading side L1, loading path P2 may pass though the loading side L2, loading path P3 may pass through L3, and loading path P4 may pass through loading side L4.

For example, when the ADU 110 serves as a shopping cart, the load may be groceries (e.g., boxes for food, vegetables, fruits, bottled water, etc.). A grocery store customer (i.e., an operator of the ADU 110) may take a box of sugar and place the box on the loading surface 111 from any direction. For example, the customer may place the sugar box over the loading side L2 through the loading path P2. Similarly, when the ADU 110 serves as luggage cart in a hotel or an airport, the load may be passengers' luggage. A passenger (i.e., the operator of the ADU 110) may place her luggage on the loading surface 111 from any direction of the base 112 through the corresponding loading path. In another scenario, when the ADU 110 serves as warehouse fulfillment cart, the load may be any goods stored in the warehouse. A warehouse employee (i.e., the operator of the ADU 110) may load/discharge inventories to the loading surface 111 from any direction of the base 112 through the corresponding loading path.

The auxiliary modules 150 may be mounted on or integrated in the ADU 110. Modules in the auxiliary modules 150 may be integrated together or distributed through different part of the ADU 110. For example, the sensor module, driving module and the communication module of the auxiliary modules 150 may be integrated in the at least one base 112; whereas the input module of the auxiliary modules 150 may remain an independent device. For example, the input module may be a keyboard device or a touch screen device communicated with the control module 140 via wired or wireless communicate. The input module 160 may be mounted on top of the arm 120. As shown in FIG. 3, the input module 160 may be mounted at a cross-joint portion of the 4 arms 120 below the vision module 130. Alternatively or additionally, the input module 160 may be mounted above the vision module 130 or on elsewhere on the base 140. Further, the input module 160 may be an integrated part of the ADU 110 or an independent part detachably mounted on body 137, which is introduced elsewhere in the present disclosure.

In some embodiments, sensor module may include at least one of one or more LIDAR sensors 114, one or more ultrasonic sensors 115, or the one or more antennas 116. These sensors may be configured to collect/detect environmental information surrounding the ADU 110.

For example, the LIDAR sensor 114 may be mounted on front and/or rear side of the base 140 for proximity sensing and obstacle avoidance. The ultra-sonic sensor 115 may be mounted on left or right side of the base 140 to detect and help avoid obstacles around the ADU 110.

The one or more antennas 116 may be configured/used to communicate with the control center 150 and/or communicate with other ADUs. For example, a plurality of ADUs may group and navigate together. During navigation, the ADUs may use their respective antennas to communicate each other.

The at least one arm 120 may be of a pole shape or anything with a small diameter vs. length ratio. The arm 120 may be straight or curved. One end of the arm may be connected to the base 112, and the other end of the arm may be protruding upwardly at a predetermined angle. For example, the arm 120 may stand out from the base perpendicularly or substantially perpendicularly to the loading surface 111. Alternatively, the arm 120 may protrude from the base 111 at or substantially an angle, such as 85°, 80°, 75°, 70°, 65°, or 60°. The arm 120 may be made of rigid material, such as metal pipe, or may be made of flexible material such that an operator may change the arm's shape at her wish.

The UMV 200 may include one or more arms 120. The at least one arm 120 may be of a pole shape or a shape with a small diameter vs. length ratio. The arm 120 may be straight or curved. One end (e.g., a lower end) of the arm may be connected to the base 112, and the other end (e.g., a higher end) of the arm may protrude upwardly from the base 112 at a predetermined angle. For example, the arm 120 may stand out from the base perpendicularly or substantially perpendicularly to the loading surface 111. Alternatively, the arm 120 may protrude from the base 111 at or substantially an angle, such as 85°, 80°, 75°, 70°, 65°, or 60°. The arm 120 may be made of rigid material, such as metal pipe, or may be made of flexible material such that an operator may bend the arm into any shape at her wish.

FIG. 3 shows an exemplary embodiment of the UMV 200 having four (4) arms 120. For example, each arm may be of a pole shape with a lower end connected to the base 112. A lower portion of each arm 120 may be straight, perpendicularly or substantially perpendicularly protruding from the base 112. An upper portion of the 4 arms 120 may curve inwardly and meet with each other over the base 110, forming the cross-joint portion.

The arm 120 may be designed and mounted on the base 112 without obstructing a process of placing loads on the base from any loading side of the base 112 through the loading path. For example, the arm 120 may be located in a place that does not obstruct the loading paths. For example, each of the 4 arms as shown in FIG. 3 is located close to at least one loading side L1, L2, L3, and L4 of the base 112. Specifically, each arm 120 is close to a corner of the base 112. Because each arm is designed to have a small diameter length ratio (e.g., pole-shaped), the arms 120 do not obstruct any of the loading paths P1, P2, P3, and P4, i.e., the arms 120 do not obstruct loading goods from any side of the ADU 110. Accordingly, an operator may choose any convenient loading paths over the corresponding loading sides to place loads to the loading surface 111.

Additionally or alternatively, the arm 120 may be placed at or substantially close to a center of the base 112, so that loading/discharging goods from all loading sides of the base 112 may be free from obstruction.

Alternative to the design of multiple arms, the ADU 110 may also include only one arm 120. The arm 120 may be placed close to the corner of the base 112 (e.g., when the base 112 is polygonal-shaped) or may be placed close to or substantially close to the center of the base 112 (e.g., when the base is of any shape). The shape of the arm 120 may be straight or curved, rigid or flexible (so that an operator may bend the arm to any shape she wishes).

One of ordinary skill in the art may understand that any number, shape, or material of the arms, as long as they properly serve the functionality described in the present disclosure, may be adopted in the design of the ADU 110.

While the lower ends of the one or more arms 120 are used to fix the one or more arms 120 to the base 112, the upper portion of the one or more arms 120 are used to mount the vision module 130. For example, the vision module may be mounted on a highest point of the arms 120. When there is a plurality of arms mounted on the ADU 110, as shown in FIG. 3, the vision module 130 may be mounted on the point where the plurality of arms 120 meet. When only one arm 120 is mounted to the ADU 110, the vision module 130 may be mounted to the higher end of the arm.

The vision module 130 may be configured to detect and/or collect environmental information associated with the ADU 110. For example, the vision module may be configured to take images of a target object, such as an operator, and send the image to the control module 140 for target recognition. The vision module 130 may include a sensor 132 and an installation platform to fix the sensor 132 to the arm 120.

In some embodiments, the sensor may be a panorama camera, a monocular camera, a binocular camera (stereo camera), an optical proximity sensor (e.g., LIDAR or infrared emitter sensor), a sonar sensor/ultra-sonic sensor, a GPS receiver (for outdoor navigation), and/or any combination thereof.

The installation platform may include a body 137 mounted on the arms 120, and a steerable adaptor, connecting the sensor 132 to the body 137. The steerable adaptor may include a first coupling mechanism 135 and a second coupling mechanism 136 engage-able to the first coupling mechanism. The first coupling mechanism 135 may be connected to the sensor 132; the second coupling mechanism 136 may attach to the body 137. The second coupling mechanism 135 may be detachably engaged to the second coupling mechanism 136 and able to replace the sensor 132 in order to best fit operation requirements of the UMV 200.

In some embodiments, the first coupling mechanism 135 may be a gimbal, which includes a pitch axle 134a and a yaw axle 134b perpendicular to the pitch axle 134a. Mounting on the first coupling mechanism 135, the sensor 132 may be steerable along the pitch axle 134a and the yaw axle 134b. In some embodiments, the pitch axle 134a and the yaw axle 134b may be powered/motorized, so that the vision module 130 may actively steer the sensor 132 along the pitch axle 134a and the yaw axle 134b.

The vision module 130 may communicate with the control module 140 via wired or wireless communications.

The UMP 100 may include a single ADU 110 or a plurality of ADUs. Through the communication module of each ADU (e.g., through the antennas and/or transceivers therein) may communicate with both the control center 150 and other ADUs. For example, when the plurality of ADUs are grouped together, each ADU of the plurality of ADUs collects information from at least one other ADU in the group via the one or more sensors (e.g., the antennas, transceivers, vision sensors, LIDARs, infrared sensors, ultrasonic sensors, etc. or any combination thereof) to coordinate the navigation.

FIG. 8A is a schematic illustration of an interface on the screen of the control center 300 or the input module 160, showing grouping options of the UMVs. The interface may include a plurality of buttons for a user to select between a single UMV and a group of UMVs to perform a navigation assignment. For example, in FIG. 8, the interface includes 2 buttons for individual navigation and group navigation. The interface may also provide a plurality of UMV icons on the left side of the interface. Each of the icons corresponds with one or more UMVs. Those icons with the vision module may correspond with actual UMVs with a vison module mounted thereon. Those icons without the vison module may corresponds with UMVs without the vision module mounted thereon. By selecting an icon, the user may activate the UMV or UMVs corresponds with the icon. For example, when the user presses the individual navigation button, the interface may allow the user to select only one icon (either the UMVs with the vision module or the UMVs with no vision module). After selecting an UMV, the user may press the “GO” button, and the remote-control center 300 or the input module 160 may activate the corresponding UMV. When the user presses the group navigation button, the user may select multiple UMVs from the icons. The user may also provide options to select a leader/master UMV in the group of UMVs. Other UMVs in the group may automatically become follower of the leader/master UMV. When the user finishes the selection, the user may press the “GO” button and the UMVs being selected may be activated according to their status (leader/master or follower).

FIG. 8B is a schematic illustration of an interface on the screen of the control center 300 or the input module 160, showing navigation mode options of the UMVs being selected in FIG. 8A. The interface may provide to a user a plurality of navigations, such as “Following mode” and “Autonomous Navigation Mode.” The interface may also provide an option for the user to select which map she/he will let the UMV to navigate. After selecting a mode, the user may press the “GO” button to send the task to the corresponding UMV(s).

After the user pressing the “Autonomous Navigation Mode” and the “GO” button, the control center 300 or the input module 160 may further display an interface for the user to select a destination and/or a route to the destination. FIG. 8C is a schematic illustration of an interface on the screen of the control center 300 or the input module 160, showing further options the user may need to send to the UMV(s) under the autonomous after selection of the navigation mode. The interface may display the map that the user selected in FIG. 8B and a plurality of buttons for different routes for the user to select. The interface may also include selections of various destinations.

FIG. 9 is a schematic illustration of a group of UMVs 200 operating under a following mode according to exemplary embodiment of the present disclosure. For illustration purpose, the group of UMVs 200 in FIG. 4 includes three UMVs: UMV1, UMV2, UMV3. The UMV 1 may serve as a leader to follow an operator. Accordingly, the UMV1 includes all elements introduced above including the vision module.

The operator may input a command through the input device (i.e., the input module 160) of UMV1, directing the group of UMVs to operate under a “following mode.” After receiving the command, UMV1 may first recognize the operator. For example, the UMV1 may recognize the operator's face and contour using a camera sensor mounted thereon. When the face and contour match a record of people recognize information stored in the storage device in the UMV1 or a remote storage device at the control center side, UMV1 may operate the following mode. To this end, UMV1 may keep tracking the operator's position and drive the UMV 200 to keep a predetermined range of distance from the operator while autonomously avoiding any obstacle happen to interfere the following of the operator. The predetermined range of distance may be between m1 and m2, wherein m1 is a number anywhere between 0.1 m and 10 m, and m2 is a number anywhere between 0.2 and 10 m. m1<m2. For example, UMV1 may follow the operator to move from a hotel entrance to his/her room, or to pick up inventories in a warehouse. The leader UMV may save information of the route (through SLAM or other algorithm) the operator walks through to the storage device for use next time. The information of the route may include, but not limited to, width of the route, images or videos of the surrounding environment along the route, and map that the route passes through. UMV2 and UMV3 will turn on their respective sensor module to follow on another or use their respective communication port to communicate navigation information associated with a navigation route of the leader UMV1. In some embodiments, due to the fact that a following UMV may only need to follow other UMVs, not the operator, UMV2 and UMV3 may not have the arms and vision modules mounted on them if they are designed for the special purpose of following a leader UMV. The UMVs may also save the route the operator walks through to the storage device for use next time. The saved route may be stored in a local non-transitory storage medium of the UMV, the saved route may also be saved in the remote control center and then shared by all UMVs in a hotel/warehouse for use in a later autonomous navigation.

FIG. 9 is a schematic illustration of the unmanned movable vehicle operating under an autonomous navigation mode according to exemplary embodiments of the present disclosure. Under the autonomous navigation mode, the control module 140 may direct the UMV 200 to autonomously navigate towards a predetermined destination.

To this end, an operator may select the autonomous navigation mode through the input device or through the control center (e.g., the managing system of a warehouse, hotel, or grocery store), and then select the destination and task for the autonomous navigation. There may be more than one destination and more than one tasks in a navigation task. For example, in a warehouse, the warehouse employee may select, from a touch screen of the input device, the first destination as certain aisle of certain section in the warehouse, and then select the first task associated with the first destination as picking up certain inventories. The warehouse employee may then select, from the touch screen of the input device, the second destination as another aisle of another section in the warehouse, and then select the second task associated with the second destination as discharge the inventories. The warehouse employee may also select a route pre-stored in the storage medium of the control module 140 and/or in the storage medium associated with the control center 300.

As shown in FIG. 10, in respond to the command of the operator, the UMV 200 may depart from a start location A and autonomously navigate to the first destination B to load the inventory. The UMV 200 may use the pre-stored route as navigation reference, i.e., the UMV 200 may substantially following the pre-stored route but may autonomously maneuver itself to avoid obstacles. In the event that an obstacle blocks the pre-stored route, the UMV 200 may autonomously search the navigation map stored in the storage device and determine an alternative route to reach the first destination. After loading the inventory, the UMV 200 may continue navigate to the second destination to discharge the inventory.

Alternatively, the control center 300 and/or the input device 150 may display and provide a one-click function for a pre-stored task. For example, in a hotel or warehouse scenario, the operator may scan a guest's or item ID and the server in the control center may determine where to go—either the guest's room or a place pre-ordered by the guest, or the aisle that the item is stored in the warehouse.

Accordingly, the present disclosure discloses an unmanned movable platform that includes one or more unmanned moveable vehicles that are capable of operating different modes. Under the following mode, the unmanned movable vehicles use their vision sensors to follow the operator while using other sensors to collect environmental information to smartly avoid obstacles. Under the autonomous navigation mode, the unmanned movable vehicles may autonomously navigate along a pre-stored route to complete a predefined task, such as loading or discharging an inventory.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. For example, the steps in the methods of the present disclosure may not necessarily be operated altogether under the described order. The steps may also be partially operated, and/or operated under other combinations reasonably expected by one of ordinary skill in the art. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. An unmanned movable platform (UMP), comprising one or more autonomous driving units,
wherein each autonomous driving unit of the one or more autonomous driving units includes:
a base including at least one loading side and a loading surface to take load from a loading path through loading side of the base;
one or more arms connected to the base near the at least one loading side and protruded up from the base at a predetermined angle free from obstructing a process of placing load on the base from the at least one loading side through the loading path.

2. The UMP of claim 1, wherein each of the one or more autonomous driving units further includes one or more motorized casters connected to the base, each of the one or more motorized casters including:
a first axle connected to the base at a predetermined angle or at substantially the predetermined angle;
a motorized wheel passively rotatable along the first axle and actively rotatable along a second axle passing through a rotation center of the at least one wheel under a control of one or more control module; and
a connection mechanism connecting the first axle and the second axle.

3. The UMP of claim 2, wherein the motorized wheel includes:
a stator of a motor fixedly attached to the connection mechanism; and
a rotor of the motor fixedly attached to a wheel.

4. The UMP of claim 1, further comprising one or more vision modules, including one or more steerable sensors to obtain environmental information of the one or more autonomous driving units.

5. The UMP of claim 4, wherein the one or more steerable sensors further include one or more steerable platforms connecting one or more sensors to the one or more arms, enabling the one or more sensors to pivot along a yaw axis and a pitch axis of the one or more sensors.

6. The UMP of claim 1, further comprising one or more steerable sensors mounted on an upper portion of the one or more arms.

7. The UMP of claim 1, further comprising one or more sensors including at least one of:
one or more imaging devices to detect visible, infrared, or ultraviolet light, or
one or more proximity or range sensors.

8. The UMP of claim 1, further including one or more sensor modules configured to detect environmental information associated with the UMP.

9. The UMP of claim 8, wherein the one or more sensor modules includes at least one of one or more radar sensors, one or more ultrasonic sensors, or the one or more antennas.

10. The UMP of claim 9, wherein the one or more autonomous driving units includes a plurality of autonomous driving units, each autonomous driving unit of the plurality of autonomous driving units is configured to collect information from at least one other autonomous driving unit in the plurality of autonomous driving units via the one or more sensors of the UMP to coordinate with the navigation.

11. The UMP of claim 1, further comprises one or more control modules, wherein during operation, the one or more control modules:
receive environmental information associated with the UMP; and
based on the signals, direct the one or more autonomous driving units to navigate under a predetermined navigation mode.

12. The UMP of claim 11, wherein the predetermined navigation mode includes a following mode, under which the one or more control modules:
recognize the operator walking in front of the one or more autonomous driving units;
automatically direct the one or more autonomous driving units to follow the operator at a predetermined range of distance.

13. The UMP of claim 12, wherein to recognize the operator walking in front of the one or more autonomous driving, the one or more control modules further distinguish the operator from one or more interference persons detected by the one or more sensor modules.

14. The UMP of claim 1, wherein the predetermined navigation mode includes an autonomous navigation mode, under which the one or more control modules directs the UMP to autonomously navigate towards a predetermined destination.

15. The UMP of claim 14, wherein to autonomously navigate towards the predetermined destination, the one or more control modules further directs the one or more autonomous driving units to autonomously navigate using a predetermined route to the predetermined destination as a reference route.

16. The UMP of claim 11, further comprises a control center, wherein the control center includes a server mounted on the one or more autonomous driving units or remote from the one or more autonomous driving units.

17. The UMP of claim 16, wherein the control center communicates with the control module to direct the autonomous driving units to navigate.

18. The UMP of claim 1, further comprising one or more input interface including a plurality of displaying regions to display at least one of:
options of navigation mode selection;
maps of navigation for the one or more autonomous driving units;
options of navigation routes for the one or more autonomous driving units.

19. The UMP of claim 1, further comprising one or more screens mounted on an upper portion of the one or more arms.

20. The UMP of claim 19, wherein the one or more screens are mounted above or below one or more vision modules.

21. An unmanned movable platform (UMP), comprising one or more autonomous driving units,
wherein each autonomous driving unit of the one or more autonomous driving units includes:
a rectangular or substantially rectangular base including at least one loading surface to take load;
four arms connected to four corners of the base and protruded up from the base at a predetermined angle;
a screen mounted on a cross-joint portion of the four arms.

22. An unmanned movable platform (UMP), comprising a plurality of autonomous driving units in communication with one another, wherein
the plurality of autonomous driving units includes
a leader driving unit including a vision module, and
at least one follower driving units without a vision module, and
the communication includes navigation information associated with a navigation route of the leader driving unit.

23. The UMP of claim 22, wherein each of the plurality of autonomous driving units includes:
a base; and
one or more motorized casters connected to the base, each of the one or more motorized casters including:
a first axle connected to the base at a predetermined angle or at substantially the predetermined angle;
a motorized wheel passively rotatable along the first axle and actively rotatable along a second axle passing through a rotation center of the at least one wheel under a control of one or more control module; and
a connection mechanism connecting the first axle and the second axle.
